(19) United States
(12) Patent Application Publication
(10) Pub. No.: US 2024/0329360 A1
(43) Pub. Date: Oct. 3, 2024

(54) LENS DRIVING DEVICE AND CAMERA MODULE

(71) Applicant: MITSUMI ELECTRIC CO., LTD., Tokyo (JP)

(72) Inventors: Tomohiko OSAKA, Tokyo (JP); Norikazu KUDO, Tokyo (JP)

(21) Appl. No.: 18/608,759

(22) Filed: Mar. 18, 2024

(30) Foreign Application Priority Data
Mar. 28, 2023 (JP) 2023-51435

(51) Int. Cl. G02B 7/08; G02B 7/09; G03B 3/10; G03B 13/36; H04N 23/55

(52) U.S. Cl. CPC G02B 7/08; G02B 7/09; G03B 13/36; H04N 23/55; G03B 3/10

(57) ABSTRACT

A lens driving device contains at least one lens barrel, a housing for containing the at least one lens barrel therein, a support mechanism for supporting the at least one lens barrel so that the at least one lens barrel can be driven in a vertical direction, and a driving mechanism for providing driving force driving the at least one lens barrel. The support mechanism includes a first support portion fixedly provided in the housing, a second support portion provided on the at least one lens barrel, and a guide member held between the first support portion and the second support portion. Each of the first support portion and the second support portion is formed from magnetic material. The guide member is held between the first support portion and the second support portion by magnetic attraction force generated between the first support portion and the second support portion.

### CROSS-REFERENCE TO RELATED APPLICATION

The present application claims priority to Japanese Patent Application No. 2023-51435 filed on Mar. 28, 2023. The contents of the above-listed application are incorporated by reference for all purposes.

### TECHNICAL FIELD

The present disclosure generally relates to lens driving devices and camera modules, in particular to a lens driving device which uses a driving mechanism composed of a coil and a magnet to drive a lens, and a camera module including the lens driving device.

### BACKGROUND ART

Conventionally, there has been used a VCM (Voice Coil Motor) type driving mechanism composed of a coil and a magnet for driving an optical system of a camera module in an optical axis direction thereof to provide an autofocus function. For example, patent document 1 discloses a camera module 500 shown in FIG. 1 and having the autofocus function. The camera module 500 includes a lens barrel 520 that holds an optical system 510 including a lens barrel for holding an optical system 510 composed of one or more lenses, and a housing 530 for containing the lens barrel 520 therein.

FIG. 2 schematically shows a driving mechanism 540 of the camera module 500.

As shown in FIG. 2, the driving mechanism 540 includes a magnet 541 fixed on an outer peripheral surface of the lens barrel 520, a yoke 542 provided on an inner surface of the housing 530 so as to face the magnet 541 through a gap therebetween, and a coil 543 provided on the yoke 542 so as to face the magnet 541 through a gap therebetween. By supplying an electrical current from a control unit 550 to the coil 543, it is possible to generate either one of first driving force F1 in a direction for separating the lens barrel 520 from a circuit board 560 on which an image sensor is mounted and second driving force F2 in a direction for approaching the lens barrel 520 toward the circuit board 560 depending on a direction of the electrical current flowing in the coil 543. As a result, the autofocus function is provided.

Further, as shown in FIG. 2, two first containing grooves 521 are formed on the outer peripheral surface of the lens barrel 520 for respectively containing two guide balls 570 therein. On the other hand, two second containing grooves 531 are formed on the inner surface of the housing 530 for respectively containing the two guide balls 570 therein. Each of the two guide balls 570 is rotatably held between the first containing groove 521 and the second containing groove 531. Since the lens barrel 520 is supported by the housing 530 through the two guide balls 570, frictional resistance force when the lens barrel 520 is driven is reduced, and thereby it is possible to easily perform vertical movement of the lens barrel 520.

The above-mentioned two guide balls 570 are held between the lens barrel 520 and the housing 530 by repulsive force generated between the magnet 541 and an electromagnet composed of the coil 543 and the yoke 542. The repulsive force generated between the magnet 541 and the electromagnet composed of the coil 543 and the yoke 542 biases the lens barrel 520 toward the left side in FIG. 2. As a result, the two guide balls 570 are pressed against the housing 530, and thereby the two guide balls 570 are held between the lens barrel 520 and the housing 530.

In the case where the repulsive force generated between the magnet 541 provided on the lens barrel 520 and the electromagnet composed of the coil 543 and the yoke 542 is used for holding the two guide balls 570 as described above, it is necessary to dispose the yoke 542 and the coil 543 in the housing 530 with considering a magnetization direction of the magnet 541. Thus, a layout of an internal structure of the camera module 500, that is, structures and positions of the yoke 542 and the coil 543 are determined depending on a size and a shape of the magnet 541. Further, a size of an image sensor tends to be larger in recent years in response to a request of higher image quality of the camera module 500. As the size of the image sensor increases, the optical system 510 and the lens barrel 520 also tend to be larger and heavier.

If the sizes and the weights of the optical system 510 and the lens barrel 520 increase, a size of the magnet 541 provided on the outer peripheral surface of the lens barrel 520 also tends to increase in order to ensure sufficient driving force for driving the lens barrel 520. Further, in order to ensure the repulsive force for holding the two guide balls 570 between the lens barrel 520 and the housing 530, it is necessary to provide the magnet 541 at a position facing the two guide balls 570 through the lens barrel 520. As described above, in order to hold the two guide balls 570 between the lens barrel 520 and the housing 530, an arrangement position of the magnet 541 whose size is increased is necessarily determined, and further, arrangement positions and shapes of the other components (the yoke 542, the coil 543, and the like) are also necessarily determined in accordance with the determination of the arrangement position of the magnet 541. Therefore, there is a problem that a design freedom of the layout of the internal structure of the camera module 500 becomes very low.

### RELATED ART DOCUMENT

### Patent Document

Patent document 1: JP 2011-197626A

### SUMMARY OF THE INVENTION

### Problem to be Solved by the Invention

The present disclosure has been made in view of the above-mentioned problem. Accordingly, it is an object of the present disclosure to provide a lens driving device whose design freedom of an internal structure is high, and a camera module including the lens driving device.

### Means for Solving the Problem

The above object is achieved by the present disclosures defined by the following (1) and (2).

(1) A lens driving device, comprising:
at least one lens barrel for holding at least one optical system;
a housing for containing the at least one lens barrel therein;
a support mechanism for supporting the at least one lens barrel in the housing so that the at least one lens barrel can be driven in an optical axis direction of the at least one optical system; and
a driving mechanism for providing driving force driving the at least one lens barrel in the optical direction,
wherein the driving mechanism includes a coil provided on the at least one lens barrel and a magnet provided on the housing,
wherein the support mechanism includes:
   a first support portion fixedly provided in the housing so as to extend in the optical direction and at least partially face the magnet,
   a second support portion provided on the at least one lens barrel so as to face the first support portion, and
   a guide member held between the first support portion and the second support portion,
wherein each of the first support portion and the second support portion is formed from magnetic material, and
wherein the guide member is held between the first support portion and the second support portion by magnetic attraction force generated between the first support portion and the second support portion.

(2) A camera module comprising:
a lens driving device defined by the above (1); and
the at least one optical system held by the at least one lens barrel of the lens driving device.

### Effect of the Invention

In the lens driving device and the camera module of the present disclosure, each of the first support portion and the second support portion for holding the guide member is formed from the magnetic material. Therefore, each of the first support portion and the second support portion is magnetized by the magnet provided on the housing, and thus the magnetic attraction force is generated between the first support portion and the second support portion. The guide member is held between the first support portion and the second support portion by the above-mentioned magnetic attraction force. Thus, in the lens driving mechanism and the camera module of the present disclosure, it is not necessary to provide a magnet on the lens barrel for holding the guide member between the first support portion and the second support portion. As a result, layouts of inner structures of the lens driving mechanism and the camera module are not limited by the magnet, and thereby it is possible to increase design freedoms of the layouts of the inner structures of the lens driving mechanism and the camera module.

### BRIEF DESCRIPTION OF THE FIGURES

FIG. 1 is a perspective view of a conventional camera module.

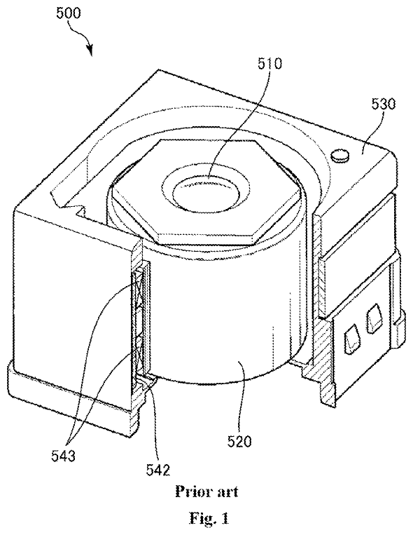

FIG. 2 is a schematic view for explaining a driving mechanism of the camera module shown in FIG. 1.

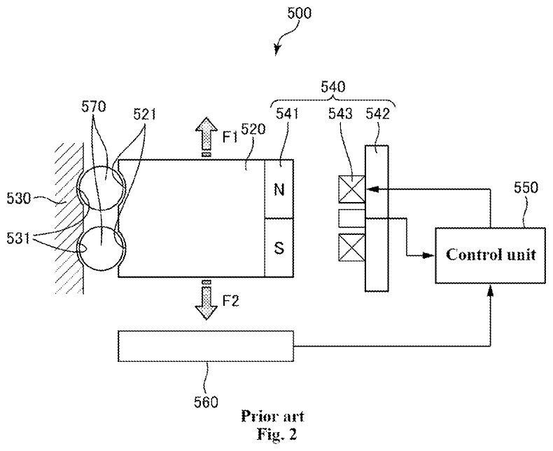

FIG. 3 is a perspective view of a camera module according to a first embodiment of the present disclosure.

FIG. 4 is an exploded perspective view of the camera module shown in FIG. 3.

FIG. 5 is an exploded perspective view of a support mechanism of the camera module shown in FIG. 3.

FIG. 6 is a horizontal cross-sectional view for showing an internal structure of the camera module shown in FIG. 3.

FIG. 7 is a longitudinal cross-sectional view showing the internal structure of the camera module shown in FIG. 3.

FIG. 8 is a perspective view of a camera module according to a second embodiment of the present disclosure.

FIG. 9 is an exploded perspective view of the camera module shown in FIG. 8.

FIG. 10 is an exploded perspective view of a lens barrel of the camera module shown in FIG. 8.

FIG. 11 is an exploded perspective view of a support mechanism of the camera module shown in FIG. 8.

FIG. 12 is a horizontal cross-sectional view showing an internal structure of the camera module shown in FIG. 8.

FIG. 13 is a longitudinal cross-sectional view for showing the internal structure of the camera module shown in FIG. 8.

FIG. 14 is an exploded perspective view of a camera module according to a third embodiment of the present disclosure.

FIG. 15 is a horizontal cross-sectional view for showing an internal structure of the camera module shown in FIG. 14.

FIG. 16 is a longitudinal sectional view for showing the internal structure of the camera module shown in FIG. 14.

### DETAILED DESCRIPTION

Hereinafter, a lens driving device and a camera module of the present disclosure will be described with reference to preferred embodiments shown in the accompanying drawings. Note that each of the figures referred in the following description is a schematic diagram prepared for explaining the present disclosure. A dimension (such as a length, a width, and a thickness) of each component shown in the drawings is not necessarily identical to an actual dimension. Further, the same reference numbers are used throughout the drawings to refer to the same or similar elements. In the following description, the Z direction of each figure may be referred to as “a vertical direction”, the positive direction of the Z axis of each figure may be referred to “an upper side”, and the negative direction of the Z axis of each figure may be referred to as “a lower side”.

### First Embodiment

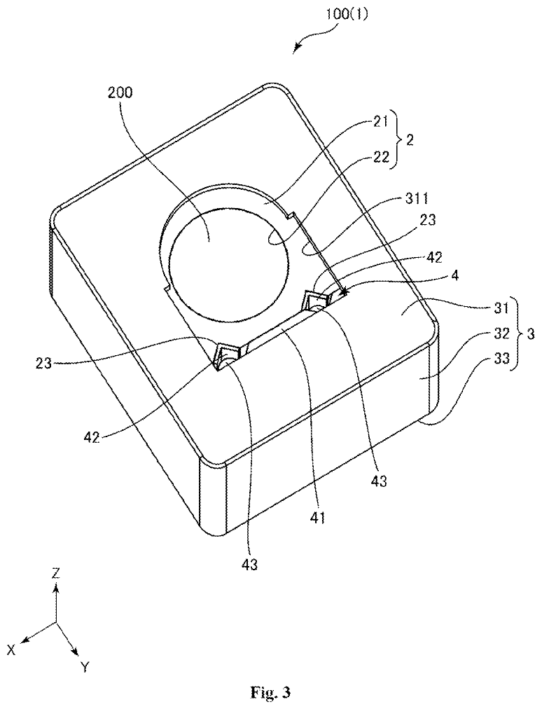

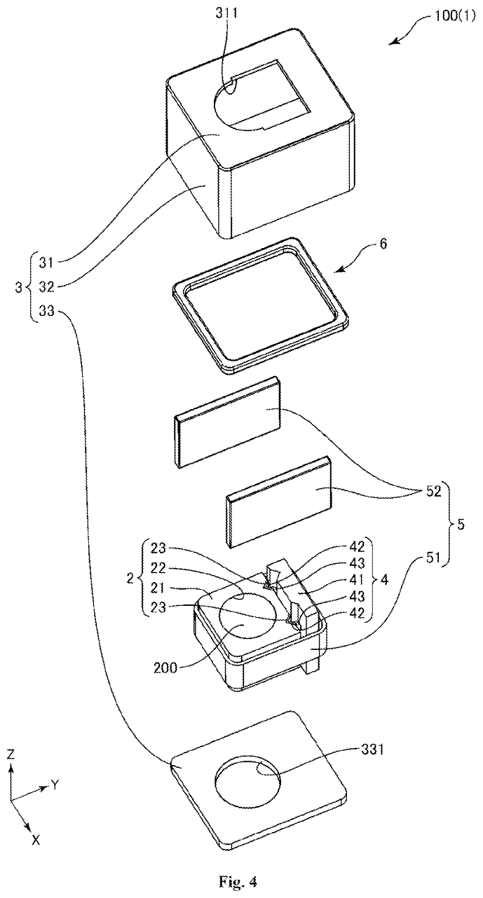

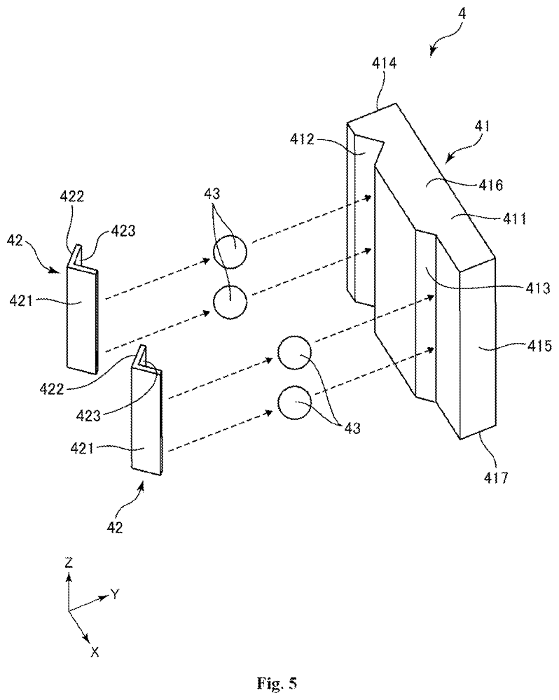

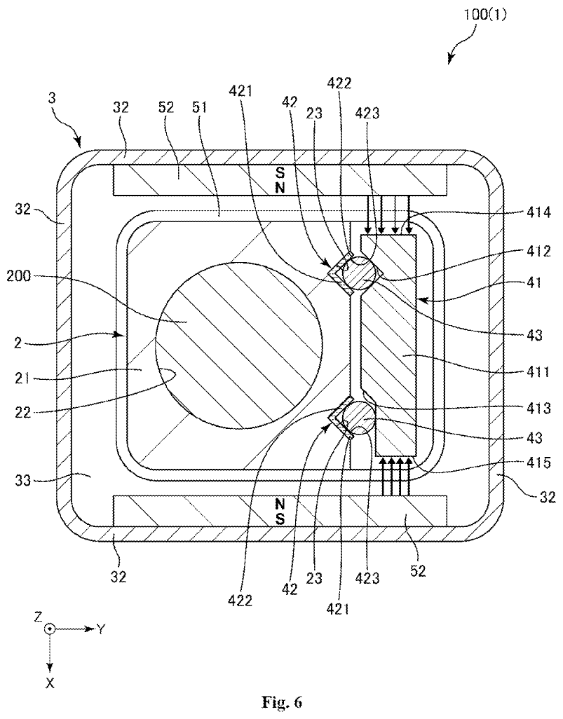

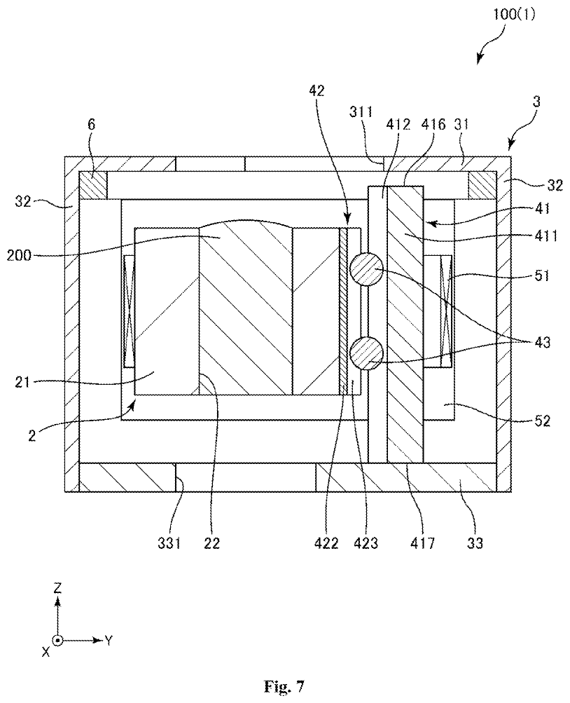

Hereinafter, a lens driving device and a camera module according to a first embodiment of the present disclosure will be described in detail with reference to FIGS. 3 to 7. FIG. 3 is a perspective view of the camera module according to the first embodiment of the present disclosure. FIG. 4 is an exploded perspective view of the camera module shown in FIG. 3. FIG. 5 is an exploded perspective view of a support mechanism of the camera module shown in FIG. 3. FIG. 6 is a horizontal cross-sectional view for showing an internal structure of the camera module shown in FIG. 3. FIG. 7 is a longitudinal cross-sectional view showing the internal structure of the camera module shown in FIG. 3.

A camera module 100 shown in FIGS. 3 and 4 according to the first embodiment of the present disclosure should be used in a smartphone, an automobile, a drone, a medical device or the like for photographing an arbitrary object. The camera module 100 includes an optical system 200 and a lens driving device 1 for holding the optical system 200 so that the optical system 200 can be driven along its optical axis direction. The camera module 100 should be mounted on a circuit board on which an image sensor is provided and used for photographing the object. In a state that the camera module 100 is mounted on the circuit board, the image sensor (not shown) for photographing an optical image formed by the optical system 200 to obtain image data is provided below the lens driving device 1. The image sensor photographs the optical image formed by the optical system 200 to obtain the image data. In this regard, although the optical system 200 is schematically illustrated in the illustrated aspect with assuming that the optical system 200 is composed of only one lens, the present disclosure is not necessarily limited thereto as long as the optical system 200 can collect light from the object to form the optical image on an imaging plane of the image sensor. The optical system 200 may be composed of one or more lenses and optical elements such as an aperture. In addition, an optical axis direction of the optical system 200 coincides with the vertical direction (the Z direction) in each figure. Thus, in the following description, the term of “vertical direction” is used with the same meaning as “the optical axis direction of the optical system 200”. Further, the term of “upper side” is used in the same meaning as “a light receiving side of the optical axis direction of the optical system 200”, and the term of “lower side” is used in the same meaning as “an imaging side of the optical axis direction of the optical system 200”.

The image sensor is mounted on the circuit board on which the camera module 100 should be mounted. The image sensor has a function of photographing the optical image formed by the optical system 200 to obtain the image data. The image sensor is provided below the lens driving device 1 so that the optical axis of the optical system 200 is substantially perpendicular to the imaging plane of the image sensor and substantially coincides with a center point of the imaging plane of the image sensor. As the image sensor, it is possible to use any image sensor known in the camera field such as a color or monochrome CCD image sensor or CMOS image sensor. The image data obtained by the image sensor is transmitted to an unillustrated control unit (for example, a control unit of an arbitrary device) through wired communication or wireless communication.

When the optical system 200 is driven in the optical axis direction by the lens driving device 1, a separation distance between the optical system 200 and the image sensor changes, and thus focus adjustment of the camera module 100 is performed. The lens driving device 1 is connected to the control unit and the lens driving device 1 drives the optical system 200 in accordance with an electrical current supplied from the control unit to the lens driving device 1. With this configuration, the autofocus function of the camera module 100 is provided.

As shown in FIG. 4, the lens driving device 1 includes a lens barrel 2 for holding the optical system 200, a housing 3 for containing the lens barrel 2 therein, a support mechanism 4 for supporting the lens barrel 2 in the housing 3 so that the lens barrel 2 can be driven in the optical axis direction of the optical system 200, a driving mechanism 5 which is composed of a coil 51 provided on the lens barrel 2 and a pair of magnets 52 provided on the housing 3 and configured to provide driving force driving the lens barrel 2 in the optical axis direction of the optical system 200, and a spacer 6 provided between the housing 3 and the pair of magnets 52.

The lens barrel 2 is a cylindrical member formed from non-magnetic material such as resin material. The lens barrel 2 has a function of holding the optical system 200 therein. The lens barrel 2 includes a rectangular cylindrical body portion 21, an insertion hole 22 formed in a substantially center portion of the body portion 21 so as to pass through the body portion 21 in the vertical direction, and two fitting recesses 23 formed on a +Y direction side lateral surface of the body portion 21.

Although the body portion 21 has a rectangular cylindrical shape in the illustrated aspect, a shape of the body portion 21 is not necessarily limited thereto as long as the coil 51 can be fixedly provided on an outer peripheral surface of the body portion 21. For example, the body portion 21 may have a circular cylindrical shape or a polygonal cylindrical shape. The insertion hole 22 is formed in the substantially center portion of the body portion 21 so as to linearly pass through the body portion 21 in the vertical direction. Although the insertion hole 22 has a circular cylindrical shape linearly passing the body portion 21 in the illustrated aspect, a shape of the insertion hole 22 is not necessarily limited thereto as long as it can hold the optical system 200 therein. For example, the scope of the present disclosure also involves an aspect in which the insertion hole 22 has a polygonal cylindrical shape and an aspect in which a plurality of grooves for respectively holding elements of the optical system 200 such as a lens and an aperture are formed on an inner peripheral surface of the insertion hole 22. By fixing the optical system 200 in the insertion hole 22 by arbitrary fixing means such as an adhesive, an adhesive tape and a retainer, the lens barrel 2 can fixedly hold the optical system 200.

The two fitting recesses 23 have a function of respectively holding after-mentioned two second support portions 42 of the support mechanism 4 therein. The two fitting recesses 23 are recessed lines formed on the body portion 21 so as to linearly extend from an upper end to a lower end of the +Y direction side lateral surface of the body portion 21. The two fitting recesses 23 extend with being spaced apart from each other and in parallel with each other. Since the two fitting recesses 23 have the same configuration, one of the fitting recesses 23 will be described in detail as a representative. Each of the two fitting recesses 23 has a shape corresponding to a −Y direction side outer shape of the second support portion 42. In the illustrated aspect, the fitting recess 23 has a V-shape whose opening width linearly increases from the −Y direction side toward the +Y direction side. The second support portion 42 is contained and fixed in the fitting recess 23. Further, an upper end and a lower end of the fitting recess 23 are not closed. Thus, the upper end of the fitting recess 23 is opened toward the upper side and the lower end of the fitting recess 23 is opened toward the lower side.

The housing 3 is a box-shaped member formed from magnetic material such as iron and SUJ2 (JIS G4805 high-carbon chromium bearing steel material) and has a function of containing the components (the lens barrel 2, the support mechanism 4, the driving mechanism 5, and the spacer 6) of the lens driving device 1 therein. Further, since the housing 3 is formed from the magnetic material and the pair of magnets 52 are provided on an inner surface of the housing 3 so as to face each other, the housing 3 can serve as a yoke for increasing a magnetic flux density between the pair of magnets 52.

The housing 3 includes a rectangular flat plate-like upper plate 31, four wall portions 32 extending from the upper plate 31 toward the lower side, and a rectangular flat plate-like base 33 facing the upper plate 31. The upper plate 31 is a rectangular flat plate-like portion which covers the components contained in an internal space of the housing 3 from the upper side. The upper plate 31 has an opening 311 for exposing the optical system 200 held by the lens barrel 2 toward the outside. The opening 311 has a rectangular portion and a semicircular portion formed so as to protrude from one side (−Y direction side area) of the rectangular portion toward the outer side. The opening 311 is formed in the upper plate 31 and at a position for allowing a radius center of the semicircular portion of the opening 311 to coincide with the optical axis of the optical system 200. Light from the object enters the optical system 200 through the opening 311, and the optical image of the object is formed by the optical system 200.

The four wall portions 32 are flat plate-like portions linearly extending from four edge portions of the upper plate 31 toward the lower side, respectively. Upper ends of the four wall portions 32 are integrally formed with the upper plate 31. The internal space of the housing 3 is defined by a lower surface of the upper plate 31, inner surfaces of the four wall portions 32 and an upper surface of the base 33. The components of the lens driving device 1 are contained in this internal space. The base 33 is a rectangular flat plate-like portion. The base 33 has a shape corresponding to the upper plate 31. Further, lower ends of the four wall portions 32 are fixed on the base 33 by arbitrary fixing means such as an adhesive. The base 33 has a circular opening 331 at a position facing the semicircular portion of the opening 311 of the upper plate 31. The light collected by the optical system 200 passes through the opening 331 and then forms the optical image on the imaging plane of the image sensor located below the base 33.

The support mechanism 4 has a function of supporting the lens barrel 2 in the internal space of the housing 3 so that the lens barrel 2 can be driven in the optical axis direction of the optical system 200. As shown in FIG. 5, the support mechanism 4 includes a first support portion 41 fixedly provided in the housing 3 and extending in the vertical direction, the two second support portions 42 fixedly provided in the two fitting recesses 23 of the lens barrel 2 respectively, and four guide members 43 held between the first support portion 41 and the second support portions 42.

As is the case of the housing 3, the first support portion 41 is formed from magnetic material such as iron and SUJ2. The first support portion 41 can be obtained by performing a cutting process on one plate material formed of the magnetic material. The first support portion 41 has a flat plate-like shape and linearly extends from the base 33 of the housing 3 along the vertical direction.

The first support portion 41 includes a flat plate-like body portion 411, a first receiving groove 412, and a second receiving groove 413. The first receiving groove 412 and the second receiving groove 413 are formed on a surface (−Y direction side surface) of the body portion 411 facing the lens barrel 2. The body portion 411 is a plate-like portion extending in the XZ plane. Each of X direction side surfaces 414 and 415 of the body portion 411 is a flat surface perpendicular to the X direction. Each of an upper surface 416 and a lower surface 417 of the body portion 411 is a flat surface perpendicular to the vertical direction. The lower surface 417 of the body portion 411 may be integrated with the upper surface of the base 33 or may be fixed on the upper surface of the base 33 by arbitrary fixing means such as an adhesive.

The first receiving groove 412 is a recessed portion linearly extending from an upper end to a lower end of the surface of the body portion 411 facing the lens barrel 2. The first receiving groove 412 has a V-shape whose opening width linearly increases from the +Y direction side toward the −Y direction side. The second receiving groove 413 is a recessed portion linearly extending from the upper end to the lower end of the surface of the body portion 411 facing the lens barrel 2 and whose +X direction side portion is opened toward the outer side. A-X direction side inner surface defining the second receiving groove 413 is an inclined surface inclined from the inner side toward the outer side. Thus, an opening width of the second receiving groove 413 linearly increases from the +Y direction side toward the −Y direction side.

The two second support portions 42 are fixedly provided in the two fitting recesses 23 of the lens barrel 2, respectively. Further, the two second support portions 42 have a function of holding the four guide members 43 between the first receiving groove 412 and the second receiving grooves 412 of the first support portion 41 and the two second support portions 42. Since the two second support portions 42 have the same configuration, one of the two second support portions 42 will be described in detail as a representative. As is the case of the housing 3, the second support portion 42 is formed from magnetic material such as iron and SUJ2. The second support portion 42 can be obtained by performing a bending process or a cutting process on one plate material formed from the magnetic material.

The second support portion 42 includes a first plate-like portion 421, a second plate-like portion 422 extending from an end portion of the first plate-like portion 421, and a receiving groove 423 defined by an inner surface of the first plate-like portion 421 and an inner surface of the second plate-like portion 422. Each of the first plate-like portion 421 and the second plate-like portion 422 is a plate-like portion linearly extending in the vertical direction and elongated in the Z direction. One long side of the first plate-like portion 421 and one long side of the second plate-like portion 422 are integrated with each other so that an angle formed by the first plate-like portion 421 and the second plate-like portion 422 becomes an arbitrary angle which is less than 180 degrees. The receiving groove 423 is defined by the inner surface of the first plate-like portion 421 and the inner surface of the second plate-like portion 422 and has a V-shape whose opening width linearly increases from the −Y direction side toward the +Y direction side. Two of the guide members 43 are held between the receiving groove 423 and the first receiving groove 412 or the second receiving groove 413 of the first support portion 41. The second support portions 42 are respectively contained in the fitting recesses 23 of the lens barrel 2 and fixed in the fitting recesses 23 of the lens barrel 2 by an adhesive.

The four guide members 43 have a function of reducing frictional resistance force when the lens barrel 2 is driven in the vertical direction. The four guide members 43 are formed from magnetic material such as iron and SUJ2. Each of the four guide members 43 can be obtained by molding of the magnetic material or performing a cutting process on plate material formed of the magnetic material. Since the four guide members 43 have the same configuration, one of the guide members 43 will be described in detail as a representative. In this regard, although the guide member 43 is a guide ball having a spherical shape in the illustrated aspect, the guide member 43 is not necessarily limited thereto as long as it can reduce the frictional resistance force when the lens barrel 2 is driven in the vertical direction. For example, it is possible to use a columnar member extending in the vertical direction as the guide member 43. Further, the number of guide members 43 to be used is not limited to the illustrated aspect, and the number of guide members 43 to be used may be appropriately changed as necessary.

The guide member 43 is held between the first receiving groove 412 or the second receiving groove 413 of the first support portion 41 and the receiving groove 423 of the second support portion 42. As described above, since the two second support portions 42 are respectively fixed in the fitting recesses 23 of the lens barrel 2, the lens barrel 2 is supported by the first support portion 41 through the two second support portions 42 and the four guide members 43 so that the lens barrel 2 can be driven in the vertical direction. The first support portion 41 is provided on the base 33 of the housing 3 which is a fixed member, and the two second support portions 42 are fixed on the lens barrel 2 which is a movable member. Thus, by connecting the fixed member and the movable member through the guide member 43, it is possible to reduce the frictional resistance force when the lens barrel 2 is driven in the vertical direction.

Referring back to FIG. 4, the driving mechanism 5 has a function of providing driving force (Lorentz force) for driving the lens barrel 2 in the vertical direction. The driving mechanism 5 includes the coil 51 provided on an outer peripheral surface of the lens barrel 2 and the pair of magnets 52 respectively provided on inner surfaces of the pair of opposing wall portions 32 of the housing 3. The coil 51 can be obtained by winding an electric wire on the outer peripheral surface of the lens barrel 2. The coil 51 is fixed on the outer peripheral surface of the lens barrel 2, and thus the coil 51 is also driven in the vertical direction together with the lens barrel 2 when the lens barrel 2 is driven in the vertical direction. Both end portions of the coil 51 are respectively connected to corresponding terminals of the control unit. Thus, it is possible to generate the driving force for driving the lens barrel 2 in accordance with a direction and a magnitude of the electrical current supplied from the control unit to the coil 51.

Each of the pair of magnets 52 is a plate-like permanent magnet. The magnets 52 are respectively provided on the inner surfaces of the pair of opposing wall portions 32 of the housing 3 so that the same poles of the pair of magnets 52 face each other (for example, an N-pole of one of the magnets 52 faces an N-pole of the other one of the magnets 52, or a S-pole of one of the magnets 52 faces a S-pole of the other one of the magnets 52). The pair of magnets 52 are respectively fixed on the inner surfaces of the pair of opposing wall portions 32 of the housing 3 by arbitrary fixing means such as an adhesive and/or its own magnetic force.

The spacer 6 is formed from non-magnetic material such as resin material. The spacer 6 fills a space between the upper plate 31 of the housing 3 and upper ends of the pair of magnets 52. The spacer 6 is a hollow member having a shape corresponding to a marginal portion of the upper plate 31. The spacer 6 is fixed on the lower surface of the upper plate 31 by arbitrary means such as an adhesive.

Next, detailed description will be given to a layout of an internal structure of the camera module 100 will with reference to FIGS. 6 and 7. FIG. 6 is a horizontal cross-sectional view of the camera module 100 in the XY plane passing through a center of the upper guide member 43 among the two vertically aligned guide members 43. FIG. 7 is a longitudinal cross-sectional view of the camera module 100 in the YZ plane passing through centers of the two guide members 43 vertically aligned in the first receiving groove 412 of the first support portion 41.

As shown in FIG. 6, the pair of magnets 52 are respectively provided on the inner surfaces of the pair of opposing wall portions 32 (the pair of wall portions 32 extending in the Y direction) of the housing 3. Further, the lens barrel 2, the support mechanism 4 (the first support portion 41, the two second support portions 42, and the four guide members 43), the coil 51, and the optical system 200 are located between the pair of magnets 52 which face each other. Further, the lens barrel 2, the support mechanism 4, and the optical system 200 are located on the inner side of the coil 51.

Since each of the housing 3, the first support portion 41, the second support portions 42, and the guide members 43 is formed from the magnetic material as described above, they can serve as yokes. Thus, a magnetic circuit is formed by the pair of magnets 52, the housing 3, the first support portion 41, the second support portions 42, and the guide members 43. In particular, the side surfaces 414, 415 of the first support portion 41 are respectively located close to the pair of magnets 52 and face the pair of magnets 52. Thus, a density of magnetic field lines indicated by arrow lines in FIG. 6 increases between the side surfaces 414, 415 of the first support portion 41 and the pair of magnets 52. With this configuration, it is possible to increase the driving force (Lorentz force) generated when electric power is supplied to the coil 51.

Further, each of the first support portion 41, the second support portions 42, and the guide members 43 is formed from the magnetic material and is located between the pair of magnets 52. Thus, each of the first support portion 41, the second support portions 42, and the guide members 43 is magnetized by the magnetic force of the pair of magnets 52. In this regard, a magnetic relationship between the upper surface 416 of the first support portion 41 and the upper plate 31 of the housing 3 and a magnetic relationship between the lower surface 417 of the first support portion 41 and the base 33 of the housing 3 also contribute to the magnetization of the first support portion 41, the second support portions 42, and the guide members 43.

In particular, since each of the first support portion 41 and the second support portions 42 is magnetized, magnetic attraction force is generated between the first support portion 41 and the second support portions 42. Thus, the lens barrel 2 is biased against the first support portion 41 by this magnetic attraction force. With this configuration, it is possible to strongly hold the guide members 43 between the first support portion 41 and the second support portions 42.

Further, since each of the four guide members 43 is also magnetized as described above, magnetic attraction force between the guide members 43 and the first support portion 41 and magnetic attraction force between the guide members 43 and the second support portions 42 are also generated. Thus, the guide members 43 are strongly held between the first support portion 41 and the second support portions 42 by the magnetic attraction force between the guide members 43 and the first support portion 41 and the magnetic attraction force between the guide members 43 and the second support portions 42 in addition to the above-mentioned magnetic attraction force between the first support portion 41 and the second support portions 42.

Further, regarding the guide members 43 on the upper side (the −X direction side) in FIG. 6, a contact between the first receiving groove 412 of the first support portion 41 and each of the guide members 43 is a two-point contact. Similarly, a contact between the receiving groove 423 of the second support portion 42 and each of the guide members 43 is a two-point contact. Thus, a connection between the lens barrel 2 and the first support portion 41 through the guide members 43 located on the upper side (the −X direction side) in FIG. 6 becomes strong, and the guide members 43 located on the upper side (the −X direction side) in FIG. 6 serve as a main axis for the driving of the lens barrel 2.

On the other hand, the second receiving groove 413 of the first support portion 41 is opened toward the +X direction side in order to absorb tolerances of the lens barrel 2, the first support portion 41, the second support portions 42, and the guide members 43. With this configuration, each of the guide members 43 located on the lower side (the +X direction side) in FIG. 6 is held by a three-point contact between the second receiving groove 413 of the first support portion 41 and the receiving groove 423 of the second support portion 42. Thus, the guide members 43 located on the lower side (the +X direction side) in FIG. 6 serve as a sub-axis for the driving of the lens barrel 2.

Further, as shown in FIG. 7, an upper end portion of each of the second support portions 42 is opened toward the upper side and a lower end portion of each of the second support portions 42 is opened toward the lower side. By opening the upper end portion and the lower end portion of each of the second support portions 42 in the vertical direction, it is possible to reduce magnetic attraction force generated between each of the second support portions 42 and the upper plate 31 of the housing 3 and between each of the second support portions 42 and the base 33 of the housing 3. Thus, it is possible to prevent the magnetic attraction force generated between each of the second support portions 42 and the upper plate 31 of the housing 3 and between each of the second support portions 42 and the base 33 of the housing 3 from interfering with the driving force generated by supplying the electric power to the coil 51. Although the upper surface 416 of the first support portion 41 and the upper plate 31 of the housing 3 are spaced apart from each other in the illustrated aspect, the present disclosure is not limited thereto. The scope of the present disclosure also involves an aspect in which the upper surface 416 of the first support portion 41 contacts with the upper plate 31 of the housing 3.

Since the second support portions 42 are magnetized by the pair of magnets 52 as described above, the magnetic attraction force is generated between the upper end portion of each of the second support portions 42 and the upper plate 31 of the housing 3 and between the lower end portion of each of the second support portions 42 and the base 33 of the housing 3. Thus, in a non-energized state that no electric power is supplied to the coil 51, the lens barrel 2 is fixed on the upper plate 31 or the base 33 by the magnetic attraction force. When the electrical current is supplied to the coil 51 and then the driving force generated to the lens barrel 2 exceeds the magnetic attraction force between the upper end portion of each of the second support portions 42 and the upper plate 31 or between the lower end portion of each of the second support portions 42 and the base 33, the lens barrel 2 is driven in a direction of the driving force. In this regard, for the same purpose, the opening 311 of the upper plate 31 and the opening 331 of the base 33 of the housing 3 may be formed to be larger so that both end portions of the second support portion 42 in the optical axis direction do not face the housing 3. Alternatively, the openings 311, 331 may have a shape other than the circular shape. Further, for the same purpose, portions of the upper plate 31 and the base 33 of the housing 3 respectively facing the second support portion 42 may be formed from non-magnetic material. Such aspects are also involved within the scope of the present disclosure.

In the camera module 100 of the present embodiment, the guide members 43 can be held between the first support portion 41 and the second support portions 42 by the magnetic attraction force generated between the first support portion 41 and the second support portions 42, the magnetic attraction force between the guide members 43 and the first support portion 41, and the magnetic attraction force between the guide members 43 and the second support portions 42 as described above. As a result, it becomes unnecessary to provide the magnet 52 on the outer peripheral surface of the lens barrel 2 unlike the conventional art described in the background section, and thus the layouts of the internal structures of the camera module 100 and the lens driving device 1 are not limited by the magnet 52. Therefore, according to the present disclosure, it is possible to increase design freedoms of the layouts of the internal structures of the camera module 100 and the lens driving device 1.

Although the above description has been provided with assuming that all portions of the housing 3 are formed from the magnetic material, the present disclosure is not necessarily limited thereto. The scope of the present disclosure also involves an aspect in which only portions of the housing 3 facing the first support portion 41 (for example, only the pair of wall portions 32 of the housing 3, which respectively face the pair of side surfaces 414, 415 of the first support portion 41 and on which the pair of magnets 52 are respectively provided) are formed from the magnetic material. This aspect can also magnetize the first support portion 41, the second support portions 42, and the four guide members 43 to strongly hold the guide members 43 between the first support portion 41 and the second support portions 42.

### Second Embodiment

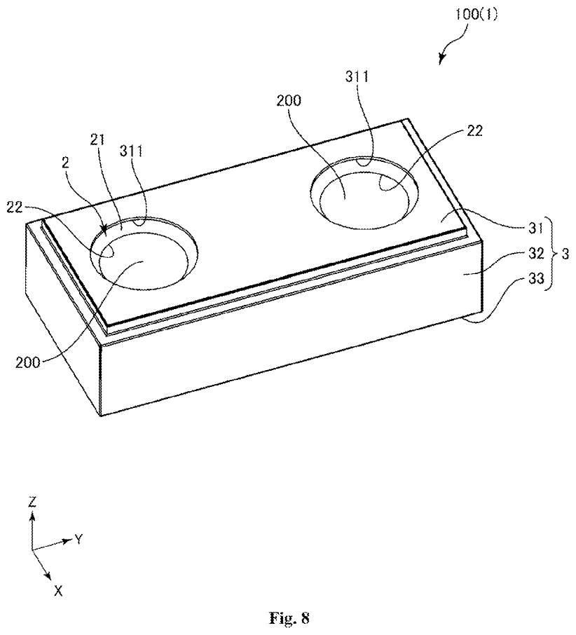

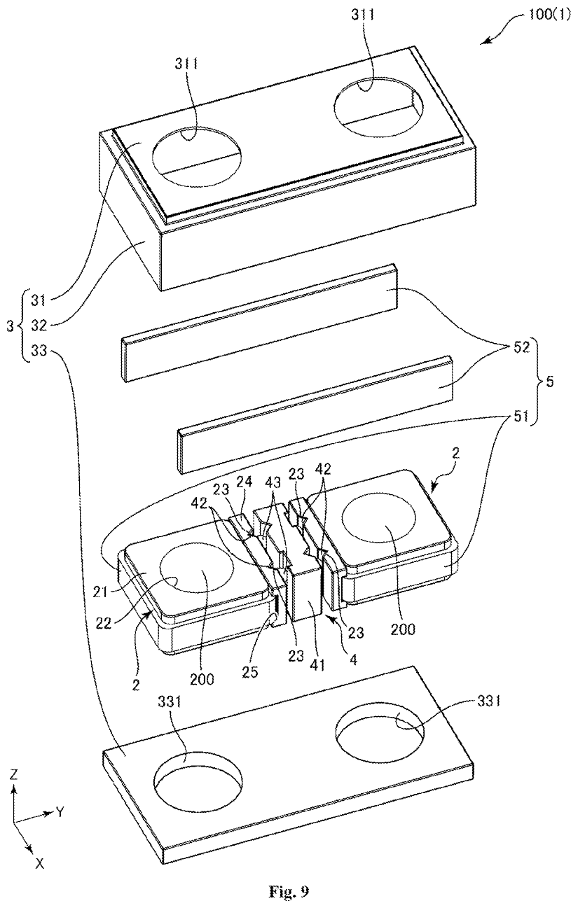

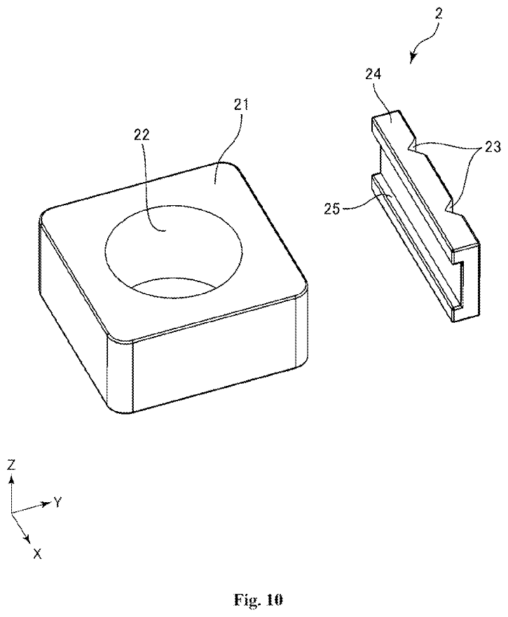

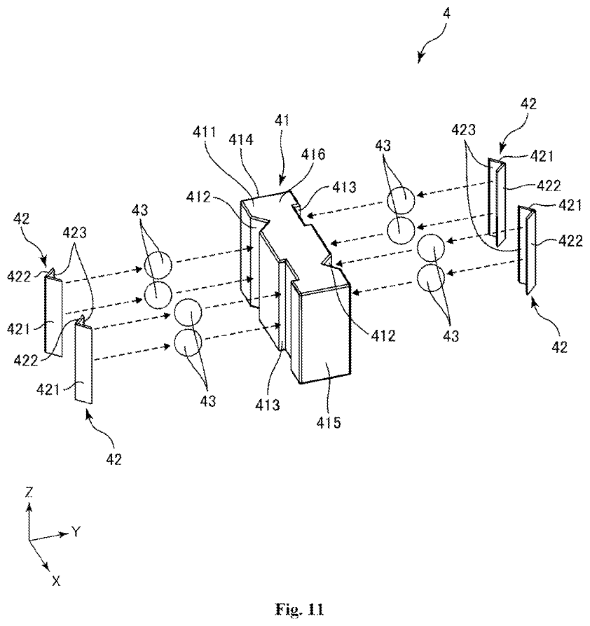

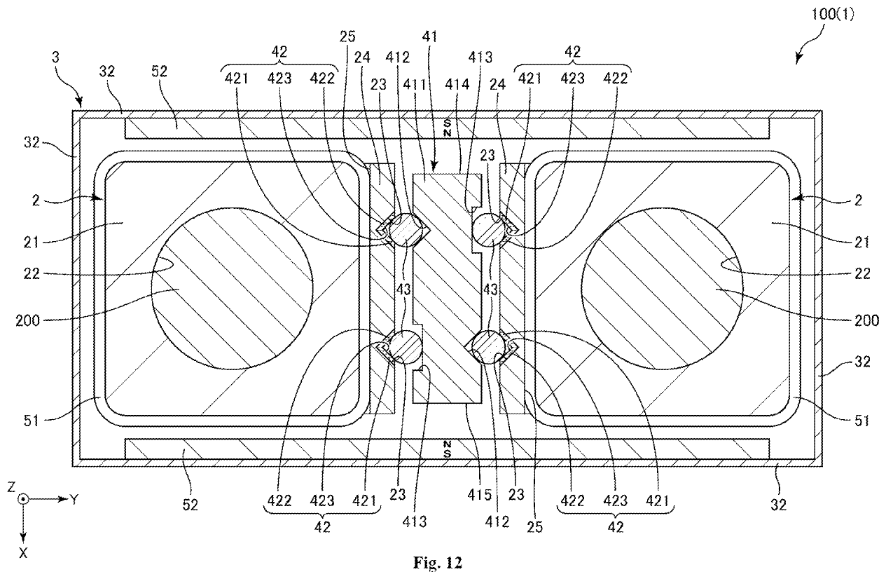

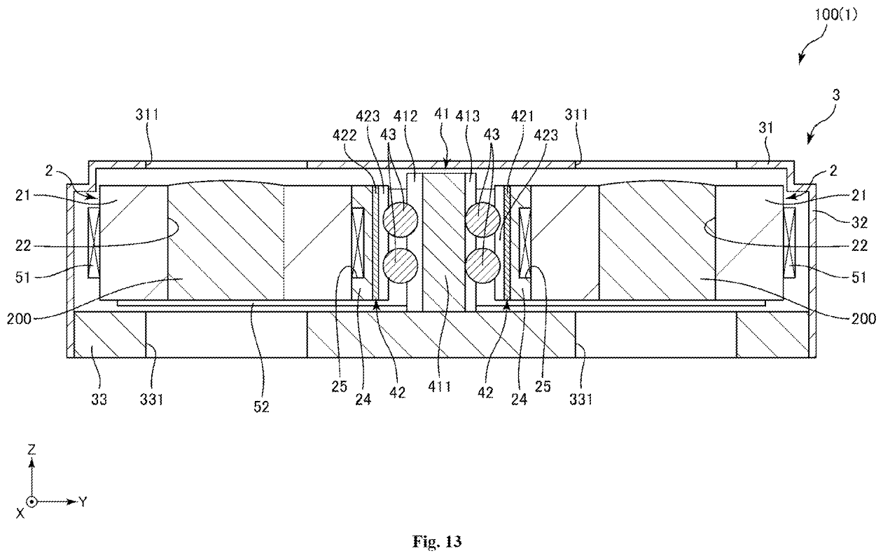

Next, a camera module and a lens driving device according to a second embodiment of the present disclosure will be described in detail with reference to FIGS. 8 to 13. FIG. 8 is a perspective view of the camera module according to the second embodiment of the present disclosure. FIG. 9 is an exploded perspective view of the camera module shown in FIG. 8. FIG. 10 is an exploded perspective view of a lens barrel of the camera module shown in FIG. 8. FIG. 11 is an exploded perspective view of a support mechanism of the camera module shown in FIG. 8. FIG. 12 is a horizontal cross-sectional view showing an internal structure of the camera module shown in FIG. 8. FIG. 13 is a longitudinal cross-sectional view for showing the internal structure of the camera module shown in FIG. 8.

The lens driving device and the camera module of the present embodiment have the same configurations as those of the lens driving device and the camera module of the first embodiment except that two lens barrels 2 are provided in the housing 3, the configuration of each of the two lens barrel 2 is modified, the configurations of the support mechanism 4 and the driving mechanism 5 are modified so that the two lens barrel 2 can be independently driven, and the spacer 6 is omitted. Thus, the lens driving device and the camera module of the second embodiment will be described by placing emphasis on the points differing from the lens driving device and the camera module of the first embodiment with the same matters being omitted from the description.

A camera module 100 of the present embodiment shown in FIGS. 8 and 9 includes two optical systems 200 arranged side by side in the Y axis direction, and a lens driving device 1 for holding the two optical systems 200 so that the two optical systems 200 can be independently driven. As shown in FIG. 9, in the present embodiment, two lens barrels 2 are arranged side by side in the internal space of the housing 3. Accordingly, a Y direction length of each of the housing 3 and the pair of magnets 52 becomes longer compared with the first embodiment. Further, the upper plate 31 of the housing 3 has two openings 311 respectively corresponding to the two optical systems 200. Similarly, the base 33 of the housing 3 has two openings 331 respectively corresponding to the two optical systems 200.

As shown in FIG. 9, since the two lens barrels 2 have the same configuration and are arranged symmetrically through the first support portion 41 of the support mechanism 4, detailed description will be given to the lens barrel 2 located on the −Y direction side as a representative. As shown in FIG. 10, the lens barrel 2 of the present embodiment includes a rectangular cylindrical body portion 21, an insertion hole 22 formed so as to pass through a substantially center portion of the body portion 21 in the vertical direction, a cover portion 24 provided on a Y direction side lateral surface of the body portion 21, a groove 25 formed on the cover portion 24, and two fitting recesses 23 formed on the cover portion 24.

The body portion 21 of the present embodiment has the same configuration as that of the body portion 21 of the first embodiment except that the two fitting recesses 23 are omitted. Further, the insertion hole 22 of the present embodiment has the same configuration as that of the insertion hole 22 of the first embodiment. The cover portion 24 is a flat member provided on a surface of the body portion 21 facing the first support portion 41 of the support mechanism 4. The cover portion 24 is formed from non-magnetic material which is the same as the constituent material of the body portion 21. The cover portion 24 has a shape corresponding to the Y direction side lateral surface of the body portion 21 and is fixed on the Y direction side lateral surface of the body portion 21 by an adhesive or the like.

The groove 25 is a recessed portion elongated in the X direction and formed on a surface of the cover portion 24 facing the body portion 21. The groove 25 linearly extends in the X direction at a vertical direction substantially center portion of the surface of the cover portion 24 facing the body portion 21. Both end portions of the groove 25 are opened toward the outside. As shown in FIG. 9, coils 51 respectively provided on outer peripheral surfaces of the body portions 21 of the lens barrels 2 respectively pass through the grooves 25 of the cover portions 24. The two fitting recesses 23 of the present embodiment have the same configuration as those of the two fitting recesses 23 of the first embodiment. In the present embodiment, the two fitting recesses 23 are formed on a surface of the cover portion 24 facing the first support portion 41 of the support mechanism 4.

FIG. 11 shows the support mechanism 4 of the present embodiment. The support mechanism 4 has a function of supporting the two lens barrels 2 in the internal space of the housing 3 so that the two lens barrels 2 can be independently driven in the optical axis direction of the optical systems 200. The support mechanism 4 includes the first support portion 41, four second support portions 42 fixedly provided in the fitting recesses 23 of the two lens barrels 2 respectively, and eight guide members 43 held between the first support portion 41 and the two second support portions 42.

The first support portion 41 includes a first receiving groove 412 and a second receiving groove 413 formed on each of surfaces respectively facing the two lens barrels 2. On the −Y direction side surface of the first support portion 41, the first receiving groove 412 is located on the −X direction side and the second receiving groove 413 is located on the +X direction side. On the other hand, on the +Y direction side surface of the first support portion 41, the first receiving groove 412 is located on the +X direction side and the second receiving groove 413 is located on the −X direction side. Each of the first receiving grooves 412 of the present embodiment has the same configuration as that of the first receiving groove 412 of the first embodiment. Each of the second receiving grooves 413 is a rectangular recessed portion linearly extending in the vertical direction. An upper end and a lower end of each of the second receiving grooves 413 are opened toward the outside. In the present embodiment, each of the second receiving grooves 413 is not opened toward the outside in the X direction and is closed. Even with this configuration, it is possible to provide the same effects and the functions as those of the second receiving groove 413 of the first embodiment described above. Each of the eight guide members 43 has the same configuration as that of the guide member 43 of the first embodiment.

Referring back to FIG. 9, the driving mechanism 5 of the present embodiment has a function of providing driving force for independently driving the two lens barrels 2 in the vertical direction. The driving mechanism 5 includes the two coils 51 respectively provided on the two lens barrels 2 and a pair of magnets 52 respectively provided on the inner surfaces of the pair of opposing wall portions 32 of the housing 3. The two coils 51 are fixedly provided on the outer peripheral surfaces of the two lens barrels 2 respectively. The two coils 51 respectively pass through the grooves 25 of the cover portions 24 of the lens barrels 2.

Each of the pair of magnets 52 is a plate-like permanent magnet. The pair of magnets 52 are respectively provided on the inner surfaces of the pair of opposing wall portions 32 of the housing 3 so that the same poles of the pair of magnets 52 face each other (for example, the N-pole of one of the magnets 52 faces the N-pole of the other one of the magnets 52, or the S-pole of one of the magnets 52 faces the S-pole of the other one of the magnets 52). The two coils 51 respectively provided on the two lens barrels 2 are located between the pair of magnets 52. Thus, in the present embodiment, the pair of magnets 52 are shared for two purposes. One of the two purposes is providing driving force for driving one of the two lens barrels 2 and the other one of the purposes is providing driving force for driving the other one of the two lens barrels 2. Both end portions of the two coils 51 are respectively connected to corresponding terminals of the control unit. The control unit can independently drive the two lens barrels 2 by independently controlling directions and magnitudes of electrical currents respectively flowing in the two coils 51.

Next, a layout of an internal structure of the camera module 100 will be described in detail with reference to FIGS. 12 and 13. FIG. 12 is a horizontal cross-sectional view of the camera module 100 in the XY plane passing through a center of the upper guide member 43 among the two vertically aligned guide members 43. FIG. 13 is a longitudinal sectional view of the camera module 100 in the YZ plane passing through centers of the four guide members 43 located on the −X direction.

As shown in FIGS. 12 and 13, the two lens barrels 2, the two optical systems 200, the two coils 51, the four second support portions 42, and the eight guide members 43 are arranged point-symmetrically around the first support portions 41. The lens barrel 2 located on the +Y direction side in FIG. 12 is held by the two second support portions 42 and the four guide members 43 located on the +Y direction side of the first support portion 41 so that it can be driven in the vertical direction with respect to the first support portion 41 provided to stand on the base 33 of the housing 3. Similarly, the lens barrel 2 located on the −Y direction side in FIG. 12 is held by the two second support portions 42 and the four guide members 43 located on the −Y direction side of the first support portion 41 so that it can be driven in the vertical direction with respect to the first support portion 41 provided to stand on the base 33 of the housing 3. As described above, the first support portion 41 of the present embodiment is shared for two purposes. One of the two purposes is holding one of the two lens barrels 2 so that the one of the two lens barrels 2 can be driven in the vertical direction and the other one of the two purposes is holding the other one of the two lens barrels 2 so that the other one of the lens barrels 2 can be driven in the vertical direction.

As described above, the camera module 100 of the present embodiment is configured to independently drive the two lens barrels 2. Further, the pair of magnets 52 are shared for the two purposes, that is providing the driving force for driving the one of the two lens barrels 2 and providing the driving force for driving the other one of the two lens barrels 2. Further, the first support portion 41 is shared for the two purposes, that is holding the one of the two lens barrels 2 so that the one of the two lens barrels can be driven in the vertical direction and holding the other one of the two lens barrels 2 so that the other one of the lens barrels 2 can be driven in the vertical direction. With this configuration, it is possible to reduce the number of components of the lens driving device 1 and simplify the configuration of the lens driving device 1. This configuration can also provide the same effects and the functions as those of the first embodiment described above.

### Third Embodiment

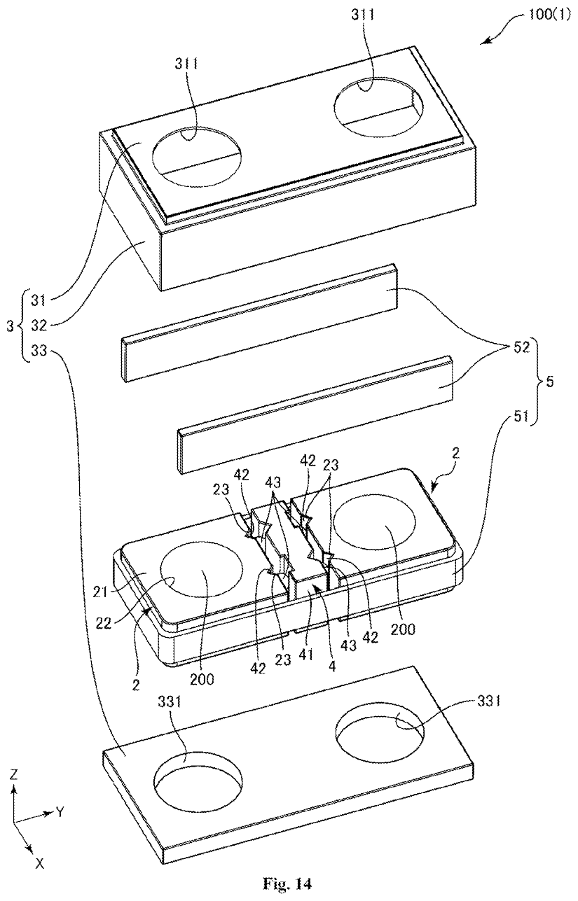

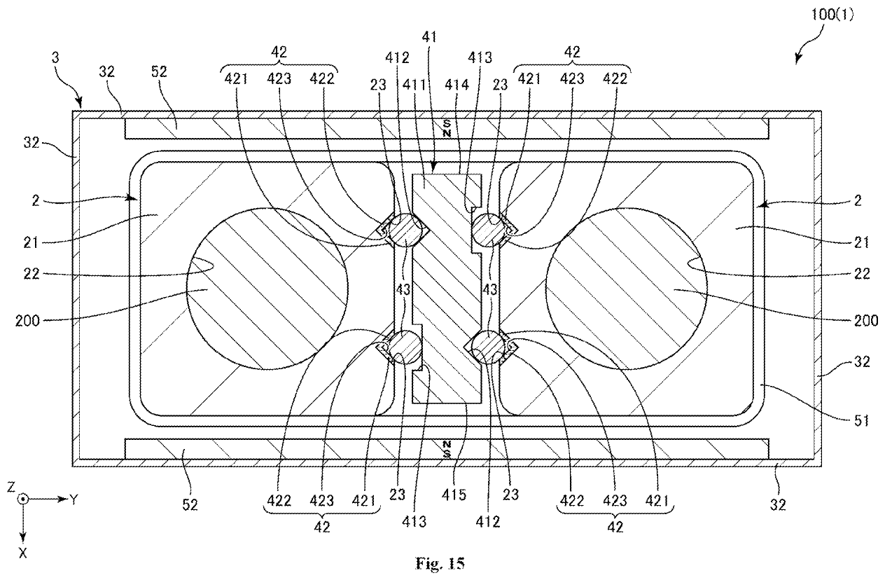

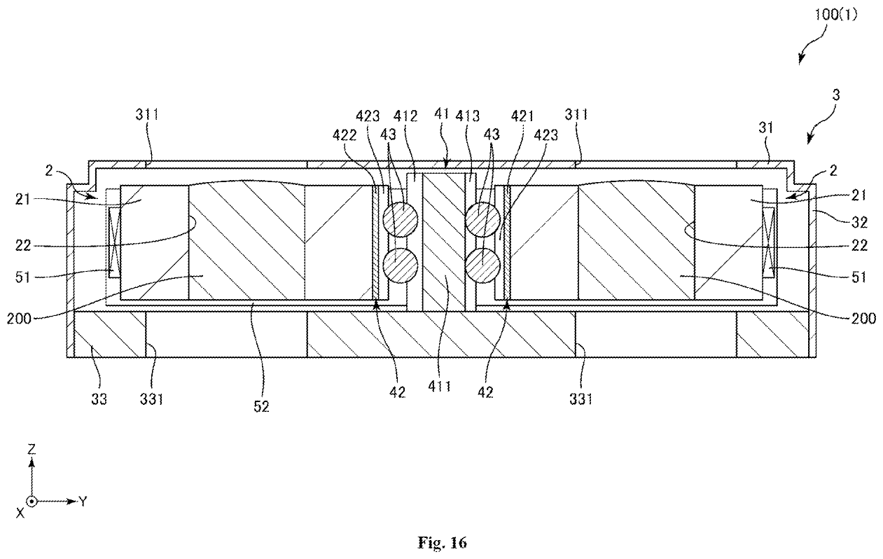

Next, a camera module and a lens driving mechanism according to a third embodiment of the present disclosure will be described in detail with reference to FIGS. 14 to 16. FIG. 14 is an exploded perspective view of the camera module according to the third embodiment of the present disclosure. FIG. 15 is a horizontal cross-sectional view for showing an internal structure of the camera module shown in FIG. 14. FIG. 16 is a longitudinal sectional view for showing the internal structure of the camera module shown in FIG. 14.

The lens driving device and the camera module of the present embodiment have the same configuration as those of the lens driving device and the camera module of the second embodiment except that the configurations of the support mechanism 4 and the driving mechanism 5 are modified so that the two lens barrels 2 can be jointly (synchronously) and simultaneously driven and the cover portions 24 are omitted. Thus, the lens driving device and the camera module of the present embodiment will be described by placing emphasis on the points differing from the lens driving device and the camera module of the second embodiment with the same matters being omitted from the description.

A lens driving device 1 and a camera module 100 of the present embodiment have the same outer shapes as the outer shapes of the lens driving device 1 and the camera module 100 of the second embodiment shown in FIG. 8. As shown in FIG. 14, compared with the lens driving device 1 and the camera module 100 of the second embodiment, the lens driving device 1 and the camera module 100 of the present embodiment are configured so that the number of coils 51 of the driving mechanism 5 is changed to one, and the two lens barrels 2 and the support mechanism 4 are located on the inner side of the one coil 51.

The coil 51 of the present embodiment is fixedly provided on the outer peripheral surfaces of the body portions 21 of the two lens barrels 2 so as to bridge over the two lens barrels 2. Thus, in the present embodiment, the one coil 51 is shared for a purpose of providing driving force for driving the two lens barrels 2. Both end portions of the coil 51 are connected to corresponding terminals of the control unit. The control unit can drive the two lens barrels 2 jointly and simultaneously by controlling a direction and a magnitude of an electrical current flowing in the coil 51. Since the coil 51 is located in the magnetic circuit constituted of the pair of magnets 52, the housing 3, the first support portion 41, the second support portions 42, and the guide members 43 and the coil 51 is fixed to the two lens barrels 2, the driving force for jointly and simultaneously driving the two lens barrels 2 in the vertical direction is generated when the electrical current is supplied to the coil 51.

Further, in the present embodiment, the cover portions 24 used in the second embodiment are omitted. Thus, each of the two lens barrels 2 of the present embodiment has the same configuration as that of the lens barrel 2 of the first embodiment. Namely, as is the case of the first embodiment, the two fitting recesses 23 are formed on the surface of the body portion 21 of each of the two lens barrels 2 facing the first support portion 41. Thus, the two second support portions 42 are respectively fixed in the two fitting recesses 23 formed on each of the body portions 21 of the lens barrels 2. Furthermore, as is the case of the two lens barrels 2 of the second embodiment, the two lens barrels 2 of the present embodiment are arranged symmetrically through the first support portion 41.

Thus, in the present embodiment, as is the case of the second embodiment, the lens barrel 2 located on the +Y direction side in FIG. 15 is held by the two second support portions 42 and the four guide members 43 located on the +Y direction side of the first support portion 41 so that the lens barrel 2 can be driven in the vertical direction with respect to the first support portion 41 provided to stand on the base 33 of the housing 3. Similarly, the lens barrel 2 located on the −Y direction side in FIG. 15 is held by the two second support portions 42 and the four guide members 43 located on the −Y direction side of the first support portion 41 so that the lens barrel 2 can be driven in the vertical direction with respect to the first support portion 41 provided to stand on the base 33 of the housing 3.

As described above, the support mechanism 4 of the present disclosure is configured to support the two lens barrels 2 so that the two lens barrels 2 can be driven in the vertical direction (the optical axis direction) jointly (synchronously) and simultaneously. Furthermore, the driving mechanism 5 is configured to drive the two lens barrels 2 in the vertical direction (the optical axis direction) jointly (synchronously) and simultaneously. The above-mentioned configuration is very effective for a case that it is necessary to jointly (synchronously) and simultaneously drive the two lens barrels 2 each holding the two optical systems 200 in order to perform a distance measurement to the object by stereo imaging. This configuration can also provide the same effects and the functions as those of the first embodiment and/or the second embodiment described above.

Although the lens driving device and the camera module of each embodiment of the present disclosure have been described based on the illustrated embodiments, the present disclosure is not limited thereto. Each configuration of each embodiment of the present disclosure can be replaced by any configuration capable of performing the same function or any configuration can be added to each configuration of each embodiment of the present disclosure.

A person having ordinary skill in the art and field will be able to perform modifications to the described configuration of the lens driving device and the camera module of each of the embodiment of the present disclosure without significantly departing from the principle, concept and scope of the present disclosure and the lens driving device and the camera module having the modified configuration are also involved within the scope of the present disclosure.

In addition, the number and the types of the components of the lens driving devices and the camera modules shown in FIGS. 3 to 16 are merely illustrative examples and the present disclosure is not necessarily limited thereto. An aspect in which any component is added or combined or any component is deleted without departing from the principle and the intent of the present disclosure is also involved within the scope of the present disclosure.

The invention claimed is:

1. A lens driving device, comprising:
at least one lens barrel for holding at least one optical system;
a housing for containing the at least one lens barrel therein;
a support mechanism for supporting the at least one lens barrel in the housing so that the at least one lens barrel can be driven in an optical axis direction of the at least one optical system; and
a driving mechanism for providing driving force driving the at least one lens barrel in the optical direction,
wherein the driving mechanism includes a coil provided on the at least one lens barrel and a magnet provided on the housing,
wherein the support mechanism includes:
a first support portion fixedly provided in the housing so as to extend in the optical direction and at least partially face the magnet,
a second support portion provided on the at least one lens barrel so as to face the first support portion, and
a guide member held between the first support portion and the second support portion,
wherein each of the first support portion and the second support portion is formed from magnetic material, and
wherein the guide member is held between the first support portion and the second support portion by magnetic attraction force generated between the first support portion and the second support portion.

2. The lens driving device claimed in claim 1, wherein the guide member is formed from magnetic material, and
wherein magnetic attraction force is generated between the guide member and the first support portion and between the guide member and the second support portion.

3. The lens driving device claimed in claim 1, wherein the coil is provided so as to surround the at least one lens barrel and the support mechanism from an outer side, and
wherein a part of the coil is located between the first support portion of the support mechanism and the magnet.

4. The lens driving device claimed in claim 1, wherein the housing includes an upper plate having a rectangular flat plate-like shape, four wall portions respectively and linearly extending from edge portions of the upper plate toward an imaging side of the optical axis direction, and a base facing the upper plate, and
wherein at least a part of the housing facing the first support portion is formed from magnetic material.

5. The lens driving device claimed in claim 4, wherein the first support portion of the support mechanism has a flat plate-like shape linearly extending from the base toward a light receiving side of the optical axis direction, and
wherein a side surface of the first support portion faces the magnet.

6. The lens driving device claimed in claim 1, wherein each of the first support portion and the second support portion includes a receiving groove for receiving the guide member,
wherein the receiving groove of each of the first support portion and the second support portion extends in the optical direction, and
wherein the guide member is held between the receiving groove of the first support portion and the receiving groove of the second support portion by the magnetic attraction force generated between the first support portion and the second support portion.

7. The lens driving device claimed in claim 1, wherein the at least one lens barrel contains two lens barrels arranged symmetrically through the first support portion of the support mechanism,
wherein the support mechanism is configured to support the two lens barrels so that the two lens barrels can be independently driven in the optical axis direction, and
wherein the driving mechanism is configured to independently drive the two lens barrels in the optical axis direction.

8. The lens driving device claimed in claim 1, wherein the at least one lens barrel contains two lens barrels arranged symmetrically through the first support portion of the support mechanism,
wherein the support mechanism is configured to support the two lens barrels so that the two lens barrels can be jointly driven in the optical axis direction, and
wherein the driving mechanism is configured to jointly drive the two lens barrels in the optical axis direction.

9. A camera module comprising:
a lens driving device defined by claim 1; and
the at least one optical system held by the at least one lens barrel of the lens driving device.
